(19) United States
(12) Patent Application Publication
(10) Pub. No.: US 2014/0028665 A1
(43) Pub. Date: Jan. 30, 2014

(54) METHOD, APPARATUS AND COMPUTER FOR GENERATING REFLECTION TEXTURE

(71) Applicant: MStar Semiconductor, Inc., Hsinchu Hsien (TW)

(72) Inventors: Hu He, Hsinchu County (TW); Lu Gao, Hsinchu County (TW)

(73) Assignee: MStar Semiconductor, Inc., Hsinchu Hsien (TW)

(21) Appl. No.: 13/948,263

(22) Filed: Jul. 23, 2013

(30) Foreign Application Priority Data
Jul. 24, 2012 (CN) 201210258450.1

(51) Int. Cl. G06T 15/04

(52) U.S. Cl. CPC G06T 15/04
USPC 345/419

(57) ABSTRACT

A method for generating a reflection texture includes steps of: obtaining a visible mirror plane area, which is formed by projecting a 3D bounding box enveloping a mirror plane to a 2D visible window; inverse mapping mirror viewpoints in the mirror plane to obtain a 3D view frustum; and symmetrically rendering a 3D object inside or intersecting the view frustum to a specular texture to generate a reflection texture. By symmetrically rendering only 3D objects inside or intersecting the view frustum, 3D objects impossibly projected to the mirror plane are eliminated to reduce the time required for rendering the specular texture.

This application claims the benefit of People's Republic of China application Serial No. 201210258450.1, filed Jul. 24, 2012, the subject matter of which is incorporated herein by reference.

### BACKGROUND OF THE INVENTION

1. Field of the Invention

The invention relates in general to image processing, and more particularly to a method, apparatus and computer for generating a reflection texture.

2. Description of the Related Art

To enhance visual effects, three-dimensional (3D) techniques are extremely prevalent in movies and games. To offer realistic visual effects, reflection effects of displaying inversed images at a lake shore in a lake image or reflected images generated by a mirror on a table from reflecting objects on the table are often involved.

In a current technique, a method for generating a specular effect is available. In the method, a 3D object in a scene is symmetrically rendered to a specular texture, which is then pasted to a mirror plane. However, in actual applications, 3D objects that are not expected to occur in the mirror plane are also rendered to the specular texture, thus not only adding a burden but also increasing the time required for the rendering process. The above issues are aggravated especially in situations of small-sized mirror planes and more dispersed 3D objects.

### SUMMARY OF THE INVENTION

The invention is directed to a method, apparatus and computer for generating a reflection texture, so as to lower a load as well as reducing the time required for a rendering process of a specular texture.

According to an aspect the present invention, a method for generating a reflection texture is provided. The method includes steps of: obtaining a visible mirror plane area, which is formed by projecting a 3D bounding box enveloping a mirror plane to a 2D visible window; inverse mapping mirror viewpoints in the mirror plane to obtain a 3D view frustum; and symmetrically rendering a 3D object inside or intersecting the view frustum to a specular texture to generate a reflection texture.

The bounding box is a 3D cuboid. An x-axis and a y-axis are defined as two perpendicular coordinate axes on a plane where the visible window is located. The step of obtaining the visible mirror plane area includes: projecting the bounding box to the 2D visible window; calculating maximum and minimum x-coordinates and a y-coordinates of projection when the bounding box is projected to the visible window; and defining a rectangular area according to the maximum and minimum x-coordinates and y-coordinates obtained from projection, wherein the rectangular area defined is the visible mirror plane area.

The step of inverse mapping the mirror viewpoints in the visible mirror plane area to obtain the 3D view frustum includes: inverse mapping the mirror viewpoints in the visible mirror plane area to obtain a local visible plane area and a remote visible plane area; and respectively utilizing the local visible plane area and the remote visible plane area as an upper base and a lower base of a prism, which is the view frustum.

The step of symmetrically rendering the 3D object inside or intersecting the view frustum to the specular texture to generate the reflection texture includes: calculating a center and a radius of a bounding box of a 3D object apart from the mirror plane; determining whether the 3D object is inside or intersects the view frustum according to the center and the radius of the bounding box; symmetrically rendering the 3D object to the specular texture when the 3D object is inside or intersects the view frustum; and repeating the above steps until all 3D objects are processed to generate the reflection texture.

The method further includes: mapping the reflection texture to the visible mirror plane area to paste the reflection texture to the mirror plane.

According to another aspect the present invention, an apparatus for generating a reflection texture is provided. The apparatus includes: a projection module, for obtaining a visible mirror plane area, which is formed by projecting a 3D bounding box enveloping a mirror plane to a 2D visible window; a projection inverse mapping module, for inverse mapping mirror viewpoints in the mirror plane to obtain a 3D view frustum; and a generation module, for symmetrically rendering a 3D object inside or intersecting the view frustum to a specular texture to generate a reflection texture, and eliminating 3D objects apart from the 3D object inside or intersecting the view frustum from the rendering process of the specular texture.

The bounding box is a 3D cuboid. An x-axis and a y-axis are defined as two perpendicular coordinate axes on a plane where the visible window is located. The projection module includes: a projection unit, for projecting the bounding box to the 2D visible window; and a first calculation unit, for calculating maximum and minimum x-coordinates and a y-coordinates of projection when the bounding box is projected to the visible window, and defining a rectangular area according to the maximum and minimum x-coordinates and y-coordinates obtained from projection, wherein the rectangular area defined is the visible mirror plane area.

The projection inverse mapping module further inverse maps the mirror viewpoints in the visible mirror plane area to obtain a local visible plane area and a remote visible plane area, and respectively utilizes the local visible plane area and the remote visible plane area as an upper base and a lower base of a prism, which is the view frustum.

The generation module includes: a second calculation unit, for calculating a center and a radius of a bounding box of a 3D object apart from the mirror plane; a determination unit, for determining whether the 3D object is inside or intersects the view frustum according to the center and the radius of the bounding box, and symmetrically rendering the 3D object to the specular texture when the 3D object is inside or intersects the view frustum.

The apparatus further includes: a mapping module, for mapping the reflection texture to the visible mirror plane area to paste the reflection texture to the mirror plane.

According to yet another aspect of the present invention, a computer is provided. The computer includes the above apparatus for generating a reflection texture.

Thus, with the method, apparatus and computer for generating a reflection texture disclosed by the present invention, only 3D objects inside or intersecting the view frustum are symmetrically rendered, and 3D objects impossibly projected to the mirror plane are eliminated to reduce the time required for rendering the specular texture.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a method for generating a reflection texture according to an embodiment of the present invention.

FIG. 2 is a flowchart of a method for generating a reflection texture according to another embodiment of the present invention.

FIG. 3 is a schematic diagram of a bounding box projected to a visible window in a method for generating a reflection texture according to an embodiment of the present invention.

FIG. 4 is a schematic diagram of inverse mapping mirror viewpoints in a visible mirror plane area in a method for generating a reflection texture according to an embodiment of the present invention.

FIG. 5 is a flowchart of determining whether a 3D object is inside or intersects a view frustum in a method for generating a reflection texture according to an embodiment of the present invention.

FIG. 6 is a block diagram of an apparatus for generating a reflection texture according to an embodiment of the present invention.

FIG. 7 is a block diagram of an apparatus for generating a reflection texture according to another embodiment of the present invention.

### DETAILED DESCRIPTION OF THE INVENTION

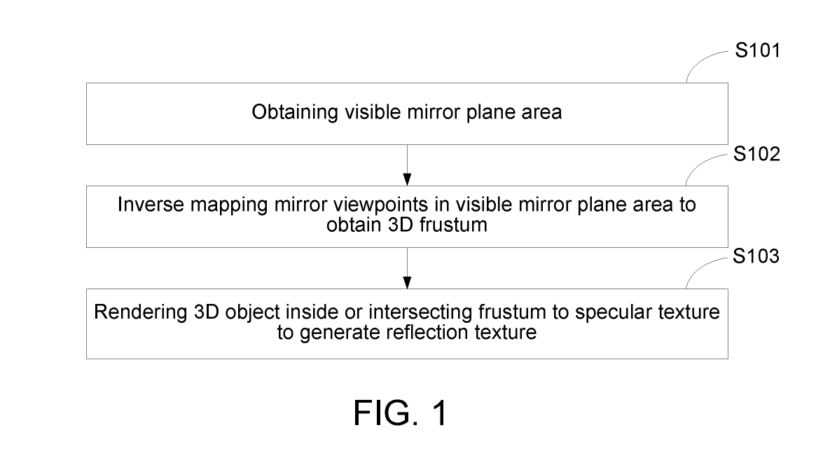

FIG. 1 shows a flowchart of a method for generating a reflection texture according to an embodiment of the present invention.

In step S101, a visible mirror plane area is obtained.

The mirror plane refers to a three-dimensional (3D) object such as a surface of a lake capable of reflecting objects at a shore into inverted images or a mirror capable of reflecting objects. Due to a possible irregular shape of the mirror plane, a bounding box having a regular shape may be provided to envelop the mirror plane in order to readily project the 3D mirror plane to a two-dimensional (2D) visible window. The bounding box is then projected to the 2D visible window to form the visible mirror plane area.

In an alternative embodiment, the mirror plane may also be projected to obtain the visible mirror plane area. Correspondingly, a bounding box exactly consistent with a mirror plane is provided to envelop the mirror plane and then projected to a 2D visible window to accordingly to form a visible mirror plane area.

In step S201, mirror viewpoints in the visible mirror plane area are inverse mapped to obtain a 3D view frustum.

Positions of viewpoints designated, and mirror viewpoints of the viewpoints are calculated by performing symmetry plane calculation according to a plane where the mirror plane is located. The mirror viewpoints in the mirror plane are inverse mapped, and the mirror plane is projected to a local plane and a remote plane to respectively form a local visible plane area and a remote visible plane area. The local visible plane area and the remote visible plane area are respectively utilized as an upper base and a lower base of a prism, which is the view frustum.

In step S103, a 3D object inside or intersecting the view frustum is symmetrically rendered to a specular texture to generate a reflection texture. Other 3D objects apart from the 3D object inside or intersecting the view frustum are eliminated from the rendering process of the specular texture.

In the embodiment of the present invention, the view frustum is obtained through calculation, and the object inside or intersecting the view frustum is symmetrically rendered to the specular texture. Thus, other 3D objects impossibly projected to the mirror plane are eliminated to lower rendering loading and to further reduce the time required for the rendering process of the specular texture.

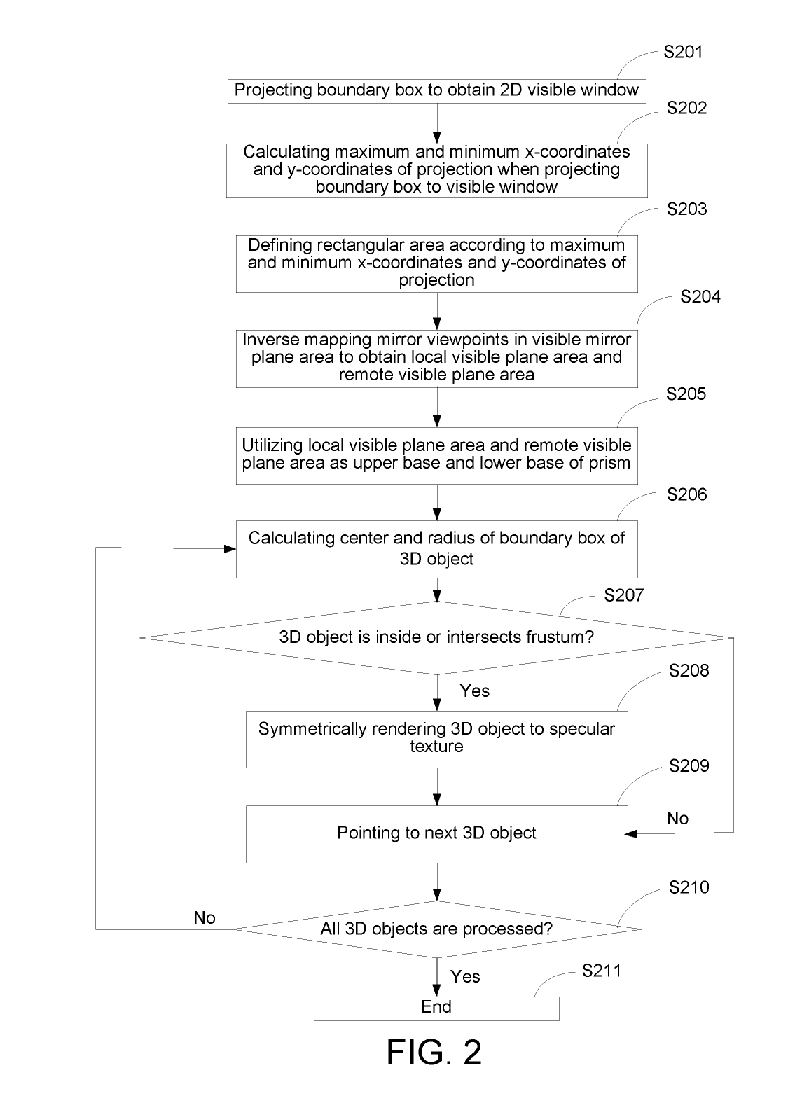

FIG. 2 shows a flowchart of a method for generating a reflection texture according to another embodiment of the present invention. The method includes the following steps.

In step S201, a bounding box is projected to a 2D visible window.

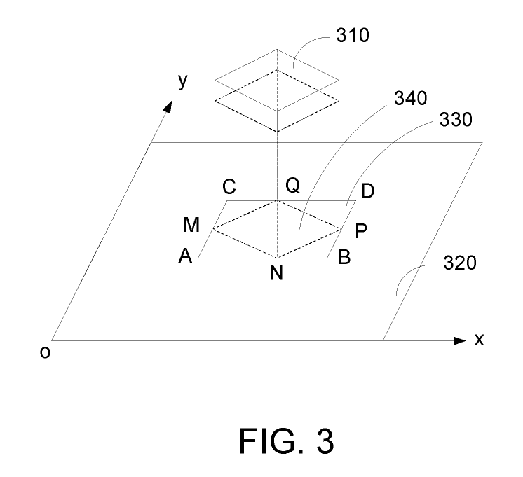

Also with reference to FIG. 3, a plane xoy is a plane where a visible window 320 is located, the x-axis and the y-axis are two coordinate axes perpendicular to each other, and the point o is a vertex of the coordinate axes. A bounding box 310 is a cuboid enveloping a mirror plane (not shown).

The mirror plane refers to 3D object such as a surface of a lake capable of reflecting objects at a shore into inverted images or a mirror capable of reflecting objects. Due to a possible irregular shape of the mirror plane, the bounding box 310 having a regular shape may be provided to envelop the mirror plane in order to readily project the 3D mirror plane to the 2D visible window 320. The bounding box 310 is then projected to the 2D visible window 320. In the embodiment, the bounding box 310 is projected to the visible window 320 to form a projection area 340, i.e., an area defined by points M, N, P and Q in FIG. 3.

In step S202, maximum and minimum x-coordinates and y-coordinates of a projection image when the bounding box is projected to the visible window are calculated.

Through calculation, it is learned that, when the bounding box 310 is projected to the visible window 320, the projection area 340 formed on the visible window 320 has a maximum x-coordinate as the horizontal coordinate of the point P, a minimum x-coordinate as the horizontal coordinate of the point M, a maximum y-coordinate as the vertical coordinate of the point Q, and a minimum y-coordinate as the vertical coordinate of the point N.

In step S203, a rectangular area is defined according to the maximum and minimum x-coordinates and y-coordinates. The rectangular area defined is the visible mirror plane area.

The horizontal coordinate of the point M (the minimum x-coordinate) and the vertical coordinate of the point N (the minimum y-coordinate) are selected to confirm a point A. The horizontal coordinate of the point P (the maximum x-coordinate) and the vertical coordinate of the point N (the minimum y-coordinate) are selected to confirm a point B. The horizontal coordinate of the point M (the minimum x-coordinate) and the vertical coordinate of the point Q (the maximum y-coordinate) are selected to confirm a point C. The horizontal coordinate of the point P (the maximum x-coordinate) and the vertical coordinate of the point Q (the maximum y-coordinate) are selected to confirm a point D. The rectangular area defined by the points A, B, C and D is a visible mirror plane area 330.

It should be noted that, given that the visible mirror plane area 330 entirely covers the projection area 340, the visible mirror plane area 330 may be other shapes such as a circle or a rhombus in other embodiments.

In step S204, mirror viewpoints in the visible mirror plane area are inverse mapped to obtain a local visible plane area and a remote visible plane area.

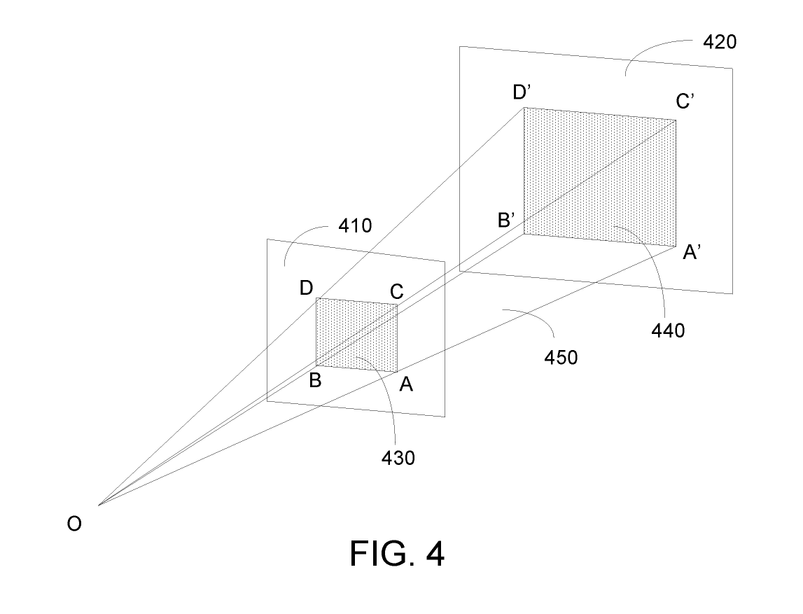

Referring to FIG. 4, by inverse mapping mirror viewpoints O in the visible mirror plane area and projecting the visible mirror plane area, a local visible plane area 430 is obtained at a local plane 410 and a remote visible plane area 440 is obtained at a remote plane 420. The local plane 410 and the remote plane 420 may be user-defined, such that 3D objects to be rendered only exist between the local plane 410 and the remote plane 420, and other 3D object exceeding the range between the local plane 410 and the remote plane 420 are not to be rendered. In the embodiment, the local plane 410 coincides with a plane where the visible mirror plane area is located. The local visible plane area 430 is formed by the points A, B, C and D, and the remote visible plane area 440 is formed by points A′, B′, C′ and D′.

In step S205, the local visible plane area and the remote visible plane area are respectively utilized as an upper base and a lower base of a prism.

A prism is defined by utilizing the local visible plane region 430 as the upper base and the remote visible plane area 440 as the lower base. The defined prism is a view frustum 450, which has an upper base, a lower base, a left side, a right side, a local side and a remote side.

In step S206, a center and a radius of a bounding box of a 3D object in a scene apart from the mirror plane are calculated.

An arbitrary 3D object in the scene apart from the mirror plane is obtained, and a bounding box having a regular shape is provided for enveloping the 3D object. The center and the radius of the bounding box enveloping the 3D object are calculated.

In step S207, it is determined whether the 3D object is inside or intersects the view frustum.

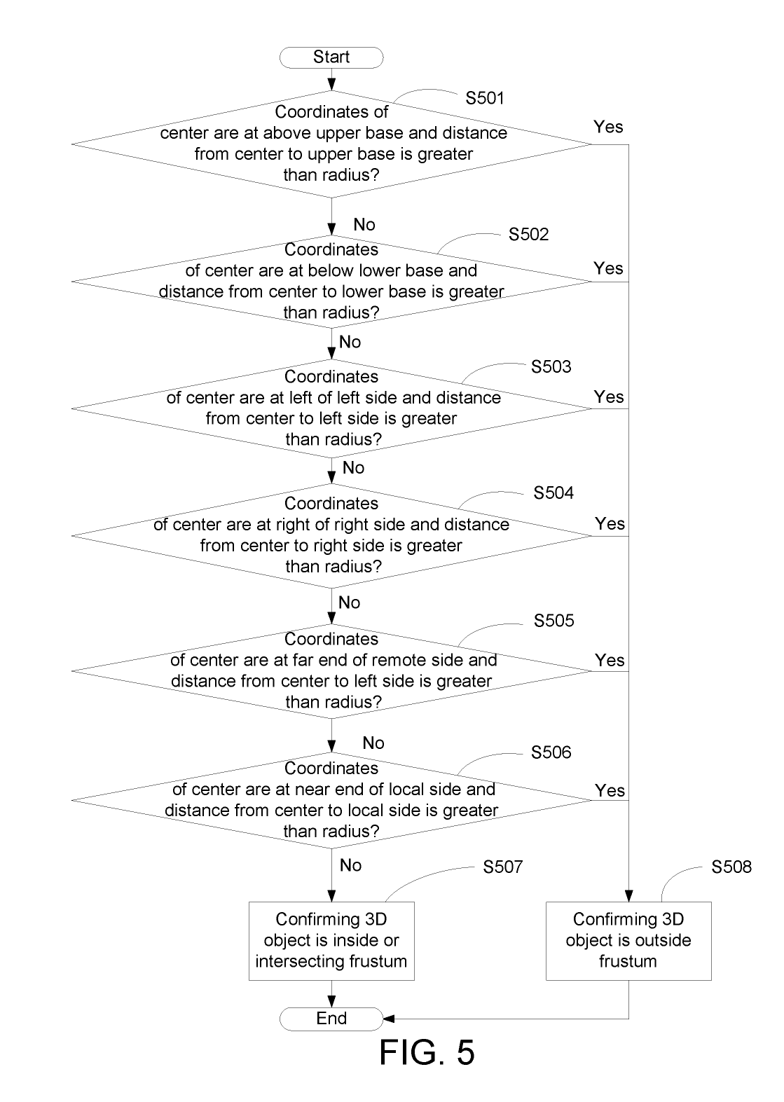

Referring to FIG. 5, distances from the center of the bounding box enveloping the 3D object to the upper base, the lower base, the left side, the right side, the local side and the remote side are calculated to determine whether the 3D object is inside the view frustum or intersects the view frustum. More specifically, the above process includes the steps below.

In step S501, it is determined whether the coordinates of the center are above the upper base and whether the distance from the center to the upper base is greater than the radius. Step S502 is performed when the determination result is negative, or else step S508 is performed when the determination result is affirmative.

In step S502, it is determined whether the coordinates of the center are below the lower base, and whether the distance from the center to the lower base is greater than the radius. Step S503 is performed when the determination result is negative, or else step S508 is performed when the determination result is affirmative.

In step S503, it is determined whether the coordinates of the center are at the left of the left side, and whether the distance from the center to the left side is greater than the radius. Step S504 is performed when the determination result is negative, or else step S508 is performed when the determination result is affirmative.

In step S504, it is determined whether the coordinates of the center are at the right of the right side, and whether the distance from the center to the right side is greater than the radius. Step S505 is performed when the determination result is negative, or else step S508 is performed when the determination result is affirmative.

In step S505, it is determined whether the coordinates of the center are at a far end of the remote side, and whether the distance from the center to the remote side is greater than the radius. Step S506 is performed when the determination result is negative, or else step S508 is performed when the determination result is affirmative.

In step S505, it is determined whether the coordinates of the center are at a near end of the local side, and whether the distance from the center to the local side is greater than the radius. Step S507 is performed when the determination result is negative, or else step S508 is performed when the determination result is affirmative.

It should be noted that, instead of the above sequence, steps S501 to S506 may be performed at a random order.

In Step S507, it is confirmed that the 3D object is inside or intersects the view frustum.

In step S508, it is confirmed that the 3D object is outside the view frustum.

Step S208 is performed when it is confirmed that the 3D object is inside or intersects the view frustum, or else step S209 is performed when it is confirmed that the 3D object is outside the view frustum.

In step S208, the 3D object inside or intersecting the view frustum is symmetrically rendered onto a specular texture.

In step S209, the process points to a next 3D object.

In step S210, it is determined whether all 3D objects are processed. The process iterates step S206 when not all 3D objects are processed, or proceeds to step S211 when all 3D objects are processed.

In step S211, the process ends.

After rendering the 3D objects to the specular texture, the reflection texture is mapped to the visible mirror plane area to paste the reflection texture to the mirror plane.

Thus, according to the embodiment of the present invention, a rectangular visible mirror plane area is employed in a way that the view frustum obtained from projection is prismatic for simplifying calculation difficulties.

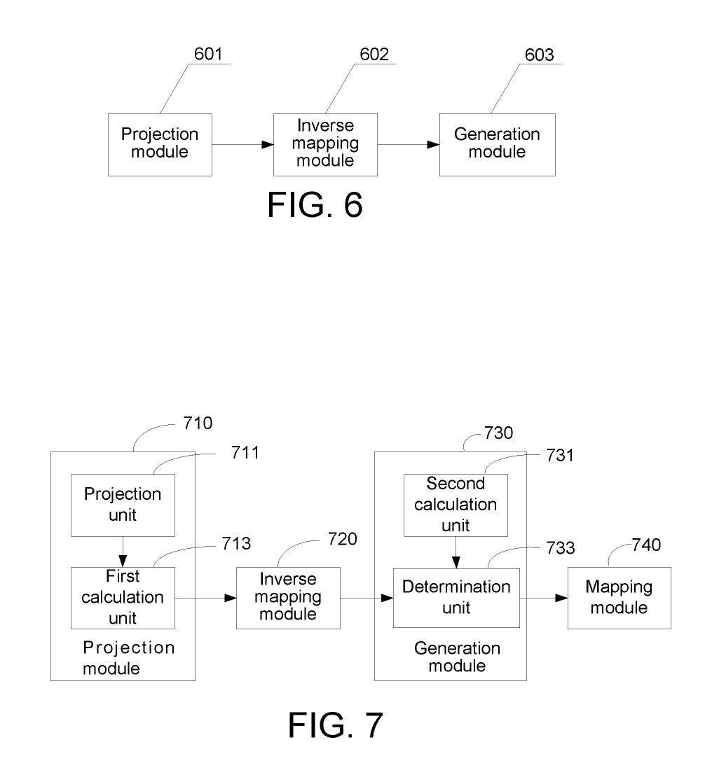

FIG. 6 shows a block diagram of an apparatus for generating a reflection texture according to an embodiment of the present invention. According to an embodiment, the apparatus for generating a reflection texture includes a projection module 601, a projection inverse mapping module 602 and a generation module 603.

The projection module 601 obtains a visible mirror plane area. The mirror plane refers to a 3D object such as a surface of a lake capable of reflecting objects at a shore into inverted images or a mirror capable of reflecting objects.

Due to a possible irregular shape of the mirror plane, a bounding box having a regular shape may be provided to envelop the mirror plane in order to readily project the 3D mirror plane to the 2D visible window. The projection module 601 then projects the bounding box to the 2D visible window to form the visible mirror plane area.

In an alternative embodiment, the mirror plane may also be projected to obtain the visible mirror plane area. Correspondingly, a bounding box exactly consistent with a mirror plane is provided to envelop the mirror plane, and the projection module 601 then projects the bounding box to the 2D visible window to form the visible mirror plane area.

The projection inverse mapping module 602 inverse maps mirror viewpoints in the visible mirror plane area to obtain a 3D view frustum. For example, positions of viewpoints are designated, and mirror viewpoints of the viewpoints are calculated by performing symmetry plane calculation according to a plane where the mirror plane is located. The mirror plane is projected to a local plane and a remote plane to respectively form a local visible plane area and a remote visible plane area. The local visible plane area and the remote visible plane area are respectively utilized as an upper base and a lower base of a prism, which is the view frustum.

The generation module 603 symmetrically renders a 3D object inside or intersecting the view frustum to a specular texture to generate a reflection texture, and eliminates other 3D objects apart from the 3D object inside or intersecting the view frustum from the rendering process of the specular texture.

In the embodiment of the present invention, the view frustum is obtained through calculation, and the object inside or intersecting the view frustum is symmetrically rendered to the specular texture. Thus, other 3D objects impossibly projected to the mirror plane are eliminated to lower rendering loading and to further reduce the time required for the rendering process of the specular texture.

FIG. 7 shows a block diagram of an apparatus for generating a reflection texture according to another embodiment of the present invention. In the embodiment, the apparatus for generating a reflection texture includes a projection module 710, a projection inverse mapping module 720, a generation module 730 and a mapping module 740. The projection module 710 includes a projection unit 711 and a first calculation unit 713. The generation module 730 includes a second calculation unit 731 and a determination unit 733.

The projection unit 711 projects a bounding box to a 2D visible window. For example, again referring to FIG. 3, the plane xoy is a plane where the visible window 320 is located, the x-axis and the y-axis are two coordinate axes perpendicular to each other, and the point o is a vertex of the coordinate axes. The bounding box 310 is a cuboid enveloping a mirror plane (not shown). The mirror plane refers to 3D object such as a surface of a lake capable of reflecting objects at a shore into inverted images or a mirror capable of reflecting objects.

Due to a possible irregular shape of the mirror plane, the bounding box 310 having a regular shape may be provided to envelop the mirror plane in order to readily project the 3D mirror plane to the 2D visible window. The projection unit 711 then projects the bounding box 310 to the 2D visible window 320.

In the embodiment, the projection unit 711 projects the bounding box 310 to the visible window 320 to form the projection area 340, i.e., the area defined by the points M, N, P and Q in FIG. 3.

The first calculation unit 713 calculates maximum and minimum x-coordinates and y-coordinates of a projection image when the bounding box is projected to the visible window, and defines a rectangular area according to the maximum and minimum x-coordinates and y-coordinates obtained from projection. The defined rectangular area is the visible mirror plane area.

For example, through calculation, it is learned that, when the bounding box 310 is projected to the visible window 320, the projection area 340 formed on the visible window 320 has a maximum x-coordinate as the horizontal coordinate of the point P, a minimum x-coordinate as the horizontal coordinate of the point M, a maximum y-coordinate as the vertical coordinate of the point Q, and a minimum y-coordinate as the vertical coordinate of the point N. The horizontal coordinate of the point M (the minimum x-coordinate) and the vertical coordinate of the point N (the minimum y-coordinate) are selected to confirm a point A. The horizontal coordinate of the point P (the maximum x-coordinate) and the vertical coordinate of the point N (the minimum y-coordinate) are selected to confirm a point B. The horizontal coordinate of the point M (the minimum x-coordinate) and the vertical coordinate of the point Q (the maximum y-coordinate) are selected to confirm a point C. The horizontal coordinate of the point P (the maximum x-coordinate) and the vertical coordinate of the point Q (the maximum y-coordinate) are selected to confirm a point D. The rectangular area defined by the points A, B, C and D is a visible mirror plane area 330.

It should be noted that, given that the visible mirror plane area 330 entirely covers the projection area 340, the visible mirror plane area 330 may be other shapes such as a circle or a rhombus in other embodiments.

The projection inverse mapping module 720 inverse maps the visible mirror plane area to obtain a local visible plane area and a remote visible plane area. The local visible plane area and the remote visible plane area are respectively utilized as an upper base and a lower base of a prism, which is the view frustum.

For example, again referring to FIG. 4, by inverse mapping the mirror viewpoints O in the visible mirror plane area and projecting the visible mirror plane area, the local visible plane area 430 is obtained at the local plane 410 and the remote visible plane area 440 is obtained at the remote plane 420. The local plane 410 and the remote plane 420 may be user-defined, such that 3D objects to be rendered only exist between the local plane 410 and the remote plane 420, and other 3D object exceeding the range between the local plane 410 and the remote plane 420 are not to be rendered.

In the embodiment, the local plane 410 coincides with a plane where the visible mirror plane area is located. The local visible plane area 430 is formed by the points A, B, C and D, and the remote visible plane area 440 is formed by points A′, B′, C′ and D′. A prism is defined by utilizing the local visible plane region 430 as the upper base and the remote visible plane area 440 as the lower base. The defined prism is a view frustum 450, which has an upper base, a lower base, a left side, a right side, a local side and a remote side.

The second calculation unit 731 calculates a center and a radius of a bounding box of a 3D object in a scene apart from the mirror plane. For example, an arbitrary 3D object in the scene apart from the mirror plane is obtained, and a bounding box having a regular shape is provided for enveloping the 3D object. The center and the radius of the bounding box enveloping the 3D object are calculated.

The determination unit 733 determines whether the 3D object is inside or intersects the view frustum. When the 3D object is located inside or intersects the view frustum, the 3D object is symmetrically rendered to the specular texture. For example, the determination unit 733 respectively calculates distances from the center of the bounding box of the 3D object to the upper base, the lower base, the left side, the right side, the local side and the remote side to confirm whether the 3D object is inside or intersects the view frustum.

Again referring to FIG. 5, the determination unit 733 stores a program corresponding to the process shown in FIG. 5. Operation details of the determination unit 733 are as discussed in descriptions associated with the above embodiments, and shall be omitted herein. The determination unit 733 symmetrically renders the 3D object inside or intersecting the view frustum to the specular texture, and eliminates other 3D objects apart from the 3D object inside or intersecting the view frustum from the rendering process of the specular texture.

After rendering the 3D object to the specular texture, the mapping module 740 maps the reflection texture to the visible mirror plane area to paste the reflection texture to the mirror plane.

Thus, according to the embodiment of the present invention, a rectangular visible mirror plane area is employed in a way that the view frustum obtained from projection is prismatic for simplifying calculation difficulties.

A computer is further provided according to the above method and apparatus for generating a reflection texture. By employing the above apparatus for generating a reflection texture, the computer realizes the method for generating a reflection texture.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for generating a reflection texture, comprising:
obtaining a visible mirror plane area, which is formed by projecting a 3D bounding box enveloping a mirror plane to a 2D visible window;
inverse mapping mirror viewpoints in the mirror plane to obtain a 3D view frustum; and
symmetrically rendering a 3D object inside or intersecting the view frustum to a specular texture to generate a reflection texture.

2. The method according to claim 1, wherein the bounding box is a 3D cuboid; an x-axis and a y-axis are defined as two perpendicular coordinate axes on a plane where the visible window is located; and the step of obtaining the visible mirror plane area comprises:
projecting the bounding box to the 2D visible window;
calculating maximum and minimum x-coordinates and a y-coordinates of projection when the bounding box is projected to the visible window; and
defining a rectangular area according to the maximum and minimum x-coordinates and y-coordinates obtained from projection, wherein the rectangular area defined is the visible mirror plane area.

3. The method according to claim 1, wherein the step of inverse mapping the mirror viewpoints in the visible mirror plane area to obtain the 3D view frustum comprises:
inverse mapping the mirror viewpoints in the visible mirror plane area to obtain a local visible plane area and a remote visible plane area; and
respectively utilizing the local visible plane area and the remote visible plane area as an upper base and a lower base of a prism, which is the view frustum.

4. The method according to claim 1, wherein step of symmetrically rendering the 3D object inside or intersecting the view frustum to the specular texture to generate the reflection texture comprises:
calculating a center and a radius of a bounding box of a 3D object in a scene apart from the mirror plane;
determining whether the 3D object is inside or intersects the view frustum according to the center and the radius of the bounding box;
symmetrically rendering the 3D object to the specular texture when the 3D object is inside or intersects the view frustum; and
repeating the above steps until all 3D objects are processed to generate the reflection texture.

5. The method according to claim 1, further comprising:
mapping the reflection texture to the visible mirror plane area to paste the reflection texture to the mirror plane.

6. An apparatus for generating a reflection texture, comprising:
a projection module, for obtaining a visible mirror plane area, which is formed by projecting a 3D bounding box enveloping a mirror plane to a 2D visible window;
a projection inverse mapping module, for inverse mapping mirror viewpoints in the mirror plane to obtain a 3D view frustum; and
a generation module, for symmetrically rendering a 3D object inside or intersecting the view frustum to a specular texture to generate a reflection texture, and eliminating 3D objects apart from the 3D object inside or intersecting the view frustum from the rendering process of the specular texture.

7. The apparatus according to claim 6, wherein the bounding box is a 3D cuboid; an x-axis and a y-axis are defined as two perpendicular coordinate axes on a plane where the visible window is located; and the projection module comprises:
a projection unit, for projecting the bounding box to the 2D visible window; and
a first calculation unit, for calculating maximum and minimum x-coordinates and a y-coordinates of projection when the bounding box is projected to the visible window, and defining a rectangular area according to the maximum and minimum x-coordinates and y-coordinates obtained from projection, wherein the rectangular area defined is the visible mirror plane area.

8. The apparatus according to claim 6, wherein the projection inverse mapping module inverse maps the mirror viewpoints in the visible mirror plane area to obtain a local visible plane area and a remote visible plane area, and respectively utilizes the local visible plane area and the remote visible plane area as an upper base and a lower base of a prism, which is the view frustum.

9. The apparatus according to claim 6, wherein the generation module comprises:
a second calculation unit, for calculating a center and a radius of a bounding box of a 3D object in a scene apart from the mirror plane;
a determination unit, for determining whether the 3D object is inside or intersects the view frustum according to the center and the radius of the bounding box, and symmetrically rendering the 3D object to the specular texture when the 3D object is inside or intersects the view frustum.

10. The apparatus according to claim 6, further comprising:
a mapping module, for mapping the reflection texture to the visible mirror plane area to paste the reflection texture to the mirror plane.

11. A computer, comprising the apparatus for generating a reflection texture according to claim 6.

12. A computer, comprising the apparatus for generating a reflection texture according to claim 7.

13. A computer, comprising the apparatus for generating a reflection texture according to claim 8.

14. A computer, comprising the apparatus for generating a reflection texture according to claim 9.

15. A computer, comprising the apparatus for generating a reflection texture according to claim 10.
